(19) United States
(12) Patent Application Publication
(10) Pub. No.: US 2024/0193666 A1
(43) Pub. Date: Jun. 13, 2024

(54) INFORMATION PROCESSING SYSTEM, INFORMATION PROCESSING METHOD, AND INFORMATION PROCESSING PROGRAM

(71) Applicant: Rakuten Asia Pte. Ltd., Singapore (SG)

(72) Inventor: Yusuke ABE, Tokyo (JP)

(73) Assignee: Rakuten Asia Pte. Ltd., Singapore (SG)

(21) Appl. No.: 18/387,309

(22) Filed: Nov. 6, 2023

(30) Foreign Application Priority Data
Dec. 12, 2022 (JP) 2022-197683

(51) Int. Cl. G06Q 30/0601

(52) U.S. Cl. CPC G06Q 30/0631

(57) ABSTRACT

An information processing device receives a request transmitted from a terminal device in response to an operation by a user on predetermined transaction object reference information that indicates a reference to the first web page and is carried by an information carrying medium. The information processing device acquires, in response to the request being received, purchase availability information indicating whether purchase of the predetermined transaction object is available. The information processing device transmits location information indicating a location of the first web page when the purchase availability information indicates that the purchase of the predetermined transaction object is available. The information processing device transmits a substitute web page carrying substitute transaction object reference information indicating a reference to a second web page for purchase of a transaction object as a substitute when the purchase availability information indicates that the purchase of the predetermined transaction object is not available.

### TECHNICAL FIELD

The present invention relates to a method for leading a user to a web page for purchase of a transaction object from an Internet medium introducing the transaction object outside a website for trading the transaction object.

### BACKGROUND ART

Conventionally, trading of transaction objects such as items for sale or services are actively performed through a network such as the Internet. For example, a user as a consumer searches for a desired transaction object on an electronic commerce site and displays a web page for purchase of the transaction object. Then, the user performs a purchase procedure of the transaction object through the web page.

In addition, a transaction object tradable on an electronic commerce site is introduced on an Internet medium outside the electronic commerce site in some cases. For example, a poster who provides content to a certain web page in a certain website posts information introducing a transaction object selected by the poster and pastes a link to the web page for purchase of the transaction object in the content. When a user who has browsed the web page selects the link, the terminal device of the user displays the web page for purchase.

Furthermore, a performance-based advertising or affiliate marketing is also known (for example, Patent Literature 1). For example, a content poster as the introducer pastes a so-called affiliate link or a script corresponding to an affiliate link on the web page as a link to the web page for purchase. When the user selects the affiliate link, a request is transmitted from the terminal device of the user to the server device of the affiliate first. Next, the server device performs redirection to an original web page for purchase of the transaction object. By receiving the request from the user, the server device associates the introducer who pasted the affiliate link with the user who has selected the affiliate link. Thereafter, when the user purchases the transaction object, a reward is given to the poster.

### CITATION LIST

### Patent Literatures

Patent Literature 1: JP 2009-86854 A

### SUMMARY OF THE INVENTION

### Problems to be Solved by the Invention

However, even if a user who is interested in the introduced transaction object selects the link to the web page for purchase of the transaction object, purchase of the transaction object may not be available. For example, when the transaction object is not in stock, the purchase cannot be made. Then, it is difficult to respond to the intention of the user who may have considered to make a purchase depending on the situation.

The present invention has been made in view of the above points, and an example of an object thereof is to provide an information processing device, an information processing method, and an information processing program capable of enhancing the possibility of purchase by a user who has performed, on a medium outside an electronic commerce site, an operation for displaying a web page for purchase of a transaction object in the electronic commerce site.

### Means for Solving the Problems

In order to solve the above problem, the invention according to claim 1 is an information processing device comprising: a reception means that receives a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page; an acquisition means that acquires, in response to the request being received by the reception means, purchase availability information indicating whether purchase of the predetermined transaction object is available; a first transmission means that transmits location information indicating a location of the first web page to the terminal device when the acquired purchase availability information indicates that the purchase of the predetermined transaction object is available; an identification means that identifies a substitute transaction object as a substitute for the predetermined transaction object when the acquired purchase availability information indicates that the purchase of the predetermined transaction object is not available; and a second transmission means that transmits a substitute web page carrying substitute transaction object reference information indicating a reference to a second web page for purchase of the identified substitute transaction object.

According to the invention, when the reference information of the first web page for purchase of the predetermined transaction object is operated by the user on the information carrying medium, purchase availability information indicating whether or not purchase of the transaction object is available is acquired. In a case where the purchase of the predetermined transaction object is available, the location information of the first web page is transmitted to the terminal device of the user. The terminal device acquires and displays the first web page from an electronic commerce site on the basis of the location information. The user can purchase the transaction object introduced through the first web page. When the purchase of the predetermined transaction object is not available, the substitute web page is transmitted to the terminal device. In the substitute web page, reference information of a second web page for a second web page is carried. When the user performs a predetermined operation on the reference information on the substitute web page displayed by the terminal device, the terminal device acquires and displays the second web page from the electronic commerce site. Performing an operation on the reference information of the first web page in the information carrying medium is an action indicating that there is a possibility that the user has become interested in the predetermined transaction object. The substitute transaction object is a transaction object that is a substitute for the predetermined transaction object. Therefore, there is a possibility that the user purchases the substitute transaction object. Therefore, in the medium outside the electronic commerce site, it is possible to increase the possibility of purchase by the user who has performed the operation for displaying the web page for purchase of the transaction object in the electronic commerce site.

The invention according to claim 2 is the information processing device according to claim 1, wherein the predetermined transaction object reference information carried by the information carrying medium includes poster identification information that identifies a poster of the predetermined transaction object reference information, and the received request includes the poster identification information included in the predetermined transaction object reference information, the information processing device further comprising a giving means that performs processing to give a reward to the poster on the basis of the poster identification information included in the received request in a case where the substitute transaction object is purchased via the second web page that is displayed by selecting the substitute transaction object reference information carried by the transmitted substitute web page.

According to the invention, when the user performs a predetermined operation on the reference information on the substitute web page, the terminal device acquires and displays the second web page from the electronic commerce site. Thereafter, when the user purchases the substitute transaction object, a reward is given to the poster who has put the reference information of the first web page on the information carrying medium. Therefore, even in a case where the purchase of the predetermined transaction object is not available, the poster introducing the predetermined transaction object can obtain an opportunity to get a reward for the introduction.

The invention according to claim 3 is the information processing device according to claim 1 or 2, wherein the acquired purchase availability information indicates whether the predetermined transaction object is in stock, in a case where the acquired purchase availability information indicates that the predetermined transaction object is in stock, the first transmission means transmits the location information, and in a case where the acquired purchase availability information indicates that the predetermined transaction object is not in stock, the identification means identifies the substitute transaction object and the second transmission means transmits the substitute web page.

According to the invention, even when the predetermined transaction object is not in stock, the possibility of purchase by the user can be improved.

The invention according to claim 4 is the information processing device according to claim 1 or 2, wherein the identification means identifies, as the substitute transaction object, a transaction object that has been confirmed to be available.

According to the invention, the substitute web page includes reference information of the second web page for purchase of a transaction object confirmed to be available. Therefore, the possibility of purchase by the user can be further enhanced.

The invention according to claim 5 is the information processing device according to claim 1 or 2, wherein the received request includes transaction object identification information for identifying the predetermined transaction object, and the identification means identifies, as the substitute transaction object, the transaction object related to the predetermined transaction object on the basis of the transaction object identification information included in the received request.

According to the invention, the substitute web page carries reference information of the second web page for purchase of the transaction object related to the predetermined transaction object. The user who is interested in the predetermined transaction object may purchase a related transaction object. Therefore, the possibility of purchase by the user can be increased.

The invention according to claim 6 is the information processing device according to claim 1 or 2, wherein the received request includes user identification information for identifying the user, and the identification means identifies, as the substitute transaction object, a transaction object that is considered, from past behavior of the user, to be possibly selected by the user on the basis of the user identification information included in the received request.

According to the invention, the reference information of the second web page for purchase of the transaction object that is considered, from the past behavior of the user, to be possibly selected by the user is carried by the substitute web page. The transaction object that is possibly selected is a transaction object that the user may be interested in. Therefore, the possibility of purchase by the user can be increased.

The invention according to claim 7 is the information processing device according to claim 1 or 2, wherein the predetermined transaction object reference information includes an affiliate link regarding the predetermined transaction object.

The invention according to claim 8 is an information processing method to be executed by computer, the method comprising: a reception step of receiving a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page; an acquisition step of acquiring, in response to the request being received in the reception step, purchase availability information indicating whether purchase of the predetermined transaction object is available; a first transmission step of transmitting location information indicating a location of the first web page to the terminal device when the acquired purchase availability information indicates that the purchase of the predetermined transaction object is available; an identification step of identifying a substitute transaction object as a substitute for the predetermined transaction object when the acquired purchase availability information indicates that the purchase of the predetermined transaction object is not available; and a second transmission step of transmitting a substitute web page carrying substitute transaction object reference information indicating a reference to a second web page for purchase of the identified substitute transaction object.

The invention according to claim 9 is an information processing program causing a computer to function as: a reception means that receives a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page; an acquisition means that acquires, in response to the request being received by the reception means, purchase availability information indicating whether purchase of the predetermined transaction object is available; a first transmission means that transmits location information indicating a location of the first web page to the terminal device when the acquired purchase availability information indicates that the purchase of the predetermined transaction object is available; an identification means that identifies a substitute transaction object as a substitute for the predetermined transaction object when the acquired purchase availability information indicates that the purchase of the predetermined transaction object is not available; and a second transmission means that transmits a substitute web page carrying substitute transaction object reference information indicating a reference to a second web page for purchase of the identified substitute transaction object.

### Effect of the Invention

According to the present invention, in the medium outside the electronic commerce site, it is possible to increase the possibility of purchase by the user who has performed the operation for displaying the web page for purchase of the transaction object in the electronic commerce site.

### BRIEF DESCRIPTION OF DRAWINGS

FIG. 1 is a diagram illustrating an example of a schematic configuration of an affiliate system S according to an embodiment;

FIG. 2 is a diagram illustrating a screen transition example in a shopper terminal 5.

FIG. 3 is a block diagram illustrating an example of a schematic configuration of an affiliate server 1 according to an embodiment.

FIG. 4 is a diagram illustrating an example of information stored in databases in the affiliate server 1.

FIG. 5 is a block diagram illustrating an example of a schematic configuration of an online shopping mall server 2 according to an embodiment.

FIG. 6 is a diagram illustrating an example of information stored in databases in the online shopping mall server 2.

FIG. 7 is a diagram illustrating an example of functional blocks of a system controller 11 in the affiliate server 1.

FIG. 8 is a diagram illustrating an example of functional blocks of a system controller 21 in the online shopping mall server 2.

FIG. 9 is a sequence diagram illustrating a processing example of the affiliate system S in a case where an item for sale that is introduced by an affiliate is available to purchase.

FIG. 10 is a sequence diagram illustrating a processing example of the affiliate system S in a case where the item for sale that is introduced by the affiliate is not available to purchase.

FIG. 11 is a sequence diagram illustrating a processing example of the affiliate system S in a case where the item for sale that is introduced by the affiliate is not available to purchase.

### DETAILED DESCRIPTION

### [1. Configuration of Affiliate System]

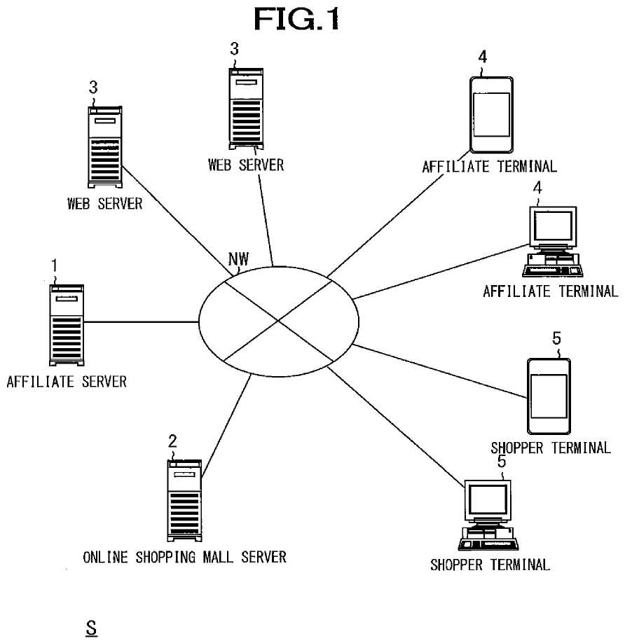

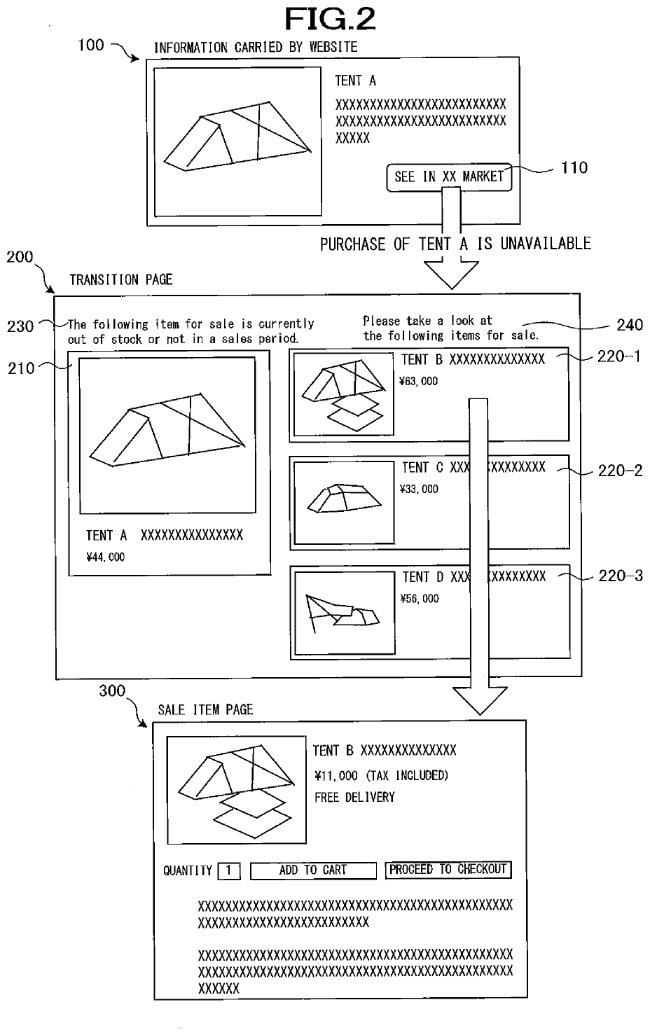

Hereinafter, an embodiment of the present invention will be described in detail with reference to the drawings. First, the outline of the configuration and function of an affiliate system S according to the present embodiment will be described with reference to FIGS. 1 and 2. FIG. 1 is a diagram illustrating an example of a schematic configuration of the affiliate system S according to the present embodiment.

As illustrated in FIG. 1, the affiliate system S includes an affiliate server 1, an online shopping mall server 2, one or a plurality of web servers 3, a plurality of affiliate terminals 4, and a plurality of shopper terminals 5. The affiliate server 1, the online shopping mall server 2, each web server 3, each affiliate terminal 4, and each shopper terminal 5 are connected to a network NW. The network NW is constructed by, for example, the Internet, a dedicated communication line (for example, a community antenna television (CATV) line), a mobile communication network (including a base station and the like), a gateway, and the like.

The affiliate server 1 is a server device managed by a certain affiliate service provider. The affiliate server 1 may perform various processes related to an affiliate service. In this affiliate service, an affiliate introduces, in some kind of information carrying medium, any transaction object sold on an electronic commerce site.

Here, the transaction object may be, for example, something that is commercially tradable. Examples of the transaction object include an item for sale and a service.

The electronic commerce site is a website where a shopper can purchase the transaction object. Examples of the electronic commerce site include online shopping malls, e-book sales sites, other online shopping sites, lodging reservation sites, golf course reservation sites, event ticket sales sites, beauty facility reservation sites, other service reservation sites, and the like. The electronic commerce site includes a web page for purchase of each transaction object sold at the electronic commerce site. This web page is referred to as a purchase page. The purchase page is a web page that enables an operation for purchasing the transaction object. In a case where the transaction object is a service, reserving the service may be relevant to purchasing the service. Examples of the operation for purchasing the transaction object include an operation for placing the transaction object in a shopping container, an operation for selecting to proceed to a purchase procedure or a reservation procedure of the transaction object, and the like. Examples of the shopping container include a shopping basket, a shopping cart, and the like. In the website in which the transaction object can be purchased, the shopper may perform a purchase procedure or a reservation procedure on the transaction object put in the shopping container.

The information carrying medium may be, for example, a digital medium or an Internet medium as means for transmitting information via the network NW. Examples of the information carrying medium include a web site, a web page, an electronic mail, an instant message, and the like. In a case where the information carrying medium is a website or a web page, the information carrying medium may be different from both the electronic commerce site and the page for purchase. Examples of the web site as the information carrying medium include a blog site, a social networking service (SNS) site, a word-of-mouth site, a video distribution site, a web site managed by an affiliate himself/herself, and the like. The web page as the information carrying medium may be a page created or managed by an affiliate. In other words, the information carrying medium may be a site of a publisher that receives a reward by posting an advertisement or the like by itself.

The online shopping mall server 2 is a server device that manages an online shopping mall. In the online shopping mall, items for sale may be sold by a plurality of stores. Each store handles one or more items for sale. In response to a request from the shopper terminal 5, the online shopping mall server 2 may search for an item for sale, transmit a web page containing information on the item for sale, or perform processing for establishing purchasing and selling of the item for sale. As a web page for purchasing an item for sale in an online shopping mall, there is a sale item page. Each sale item page is a web page on which detailed information of one item for sale corresponding to the sale item page is carried. For example, a sale item name, an image of the item for sale, the price, a description of the item for sale, and the like may be carried by the sale item page. Furthermore, the sale item page may include at least one of an operation element for putting the item for sale in the shopping basket and an operation element for proceeding to the purchase procedure of the item for sale. The operation element is an element operable by a user. Examples of the operation element include a button, an icon, a pull-down menu, and the like. According to the present embodiment, a case where an affiliate introduces an item for sale that can be purchased mainly at an online shopping mall will be described. However, the affiliate system S may include a server device that manages an electronic commerce site different from the online shopping mall.

Each web server 3 is a server device that manages a web site as an information carrying medium. For example, each web server 3 may execute processing for posting information on a web page in response to a request from the affiliate terminal 4. Examples of processing for posting information on a web page include generation of a web page on which the information is carried, update or change of the web page, storage of information carried by the web page, and the like. In addition, each web server 3 may transmit a web page to the shopper terminal 5 in response to a request from the shopper terminal 5.

Each of the affiliate terminals 4 is a terminal device used by an affiliate. For example, the affiliate terminal 4 receives and displays a web page from the affiliate server 1 or the web server 3 in response to the request from the affiliate. By using the affiliate terminal 4, the affiliate can acquire an affiliate link from the affiliate server 1 and check information regarding results of the affiliate. Examples of the affiliate include a blogger, a user of an SNS, a video streamer, a sender of a mail magazine, other information transmitters, and other content producers.

Each shopper terminal 5 is a terminal device used by a shopper who purchases a transaction object on a website. The shopper may be a user of the online shopping mall. The shopper terminal 5 receives and displays a web page from the online shopping mall server 2 or the web server 3, for example, in response to a request from a shopper. By using the shopper terminal 5, the shopper can browse an information carrying medium or purchase a transaction object on a website such as an online shopping mall.

Examples of the affiliate terminal 4 and the shopper terminal 5 include portable information terminals such as smartphones and tablet computers, mobile phones, personal digital assistants (PDAs), personal computers, and set top boxes. Each affiliate terminal 4 and each shopper terminal 5 may store a web browser.

In the affiliate system S, the affiliate server 1 issues, to each affiliate, a tag for displaying reference information of a transaction object on the information carrying medium. The reference information is information indicating a reference to the purchase page of the transaction object. When the shopper performs a predetermined operation on the reference information, the shopper terminal 5 used by the shopper displays its purchase page. The reference information may be an affiliate link. A tag for displaying an affiliate link is referred to as an affiliate tag. The affiliate can select for which transaction objects an affiliate tag is to be issued.

An affiliate posts an affiliate link on the information carrying medium by embedding the issued affiliate tag in the information carrying medium. On the information carrying medium, visual information such as text, a still image, or a moving image may be displayed as the affiliate link. This visual information may be an advertisement. Alternatively, the visual information may be information created or acquired in advance by the affiliate.

The shopper who browses the information carrying medium can display the purchase page of the transaction object introduced by the affiliate by performing a predetermined operation on the affiliate link carried by the information carrying medium. Examples of the predetermined operation include selecting the affiliate link, clicking the affiliate link, and placing a mouse pointer on the affiliate link. In the following description, it is assumed that the predetermined operation is selecting the affiliate link.

When the affiliate link carried by the information carrying medium is selected by the shopper, the shopper terminal 5 used by the shopper transmits a location request to the affiliate server 1. This location request may be, for example, information indicating a request for location information of the purchase page of the transaction object introduced by the affiliate. Alternatively, the location request may be information indicating a request of the purchase page itself. The location information of the purchase page is information indicating the location of the purchase page in the network NW. The location information may be, for example, a uniform resource locator (URL). In response to receiving the location request from the shopper terminal 5, the affiliate server 1 transmits the location information of the purchase page to the shopper terminal 5. The shopper terminal 5 that has received the location information transmits the location information to the electronic commerce site to receive the purchase page corresponding to the location information. With this configuration, automatic transfer may be performed by hypertext transfer protocol (HTTP) redirection.

In a case where the shopper purchases the transaction object on the linked electronic commerce site due to the fact that the shopper selects the affiliate link, the affiliate server 1 may execute processing of giving a reward to the affiliate. Examples of the reward given to the affiliate include money, electronic money, points in a loyalty points program, and the like. The affiliate server 1 may give a reward only when the transaction object introduced by the affiliate is purchased. Alternatively, the affiliate server 1 may give a reward even when any transaction objects sold on the electronic commerce site selling the introduced transaction object is purchased.

Here, there is a case where the transaction object corresponding to the affiliate link carried by the information carrying medium is currently unavailable. For example, in case of no stock, the transaction object cannot be purchased. In this state, even if the purchase page of the introduced transaction object is viewed, the shopper cannot purchase the transaction object. In this case, a message indicating that the unavailability may be displayed on the purchase page. Although the purchase page itself exists, the transaction object cannot be purchased, so it may be said that the affiliate link is substantially a dead link. The selection of the affiliate link may be an action indicating that the shopper is interested in the introduced transaction object. The shopper who has selected the affiliate link may consider that they might purchase the transaction object depending on the information of the transaction object carried by the purchase page. However, when the shopper finds out that the transaction object is not available, there is a high possibility that the shopper gives up the purchase. For example, there is a possibility that the shopper searches for and purchases another transaction object on the electronic commerce site including the purchase page of the reference destination by the affiliate link. Even if such a case is possible, it may take time to search for the transaction object, or the search operation may be complicated. Therefore, it is less likely that the shopper purchases any transaction object on the electronic commerce site than in a case where the transaction object for which the purchase page was displayed is available. In addition, the fact that the introduced transaction object is in an unavailable state leads to a decrease in opportunities for the affiliate to receive a reward.

Therefore, the affiliate server 1 identifies one or more substitute transaction objects that can be a substitute for the transaction object. Then, the affiliate server 1 transmits a transition page to the shopper terminal 5 instead of transmitting the URL of the purchase page of the introduced transaction object. The transition page is a web page different from the purchase page. The transition page includes reference information indicating a reference to a purchase page of a substitute transaction object. This reference information may be a link. When the shopper selects this link, the shopper terminal 5 displays the purchase page of the substitute transaction object. If the substitute transaction object is currently available for purchase, the shopper may purchase the substitute sale item. There may be some cases where the substitute transaction objects are not available. However, in the electronic commerce site, there are generally more transaction objects placed in an available state than transaction objects placed in an unavailable state. Therefore, in contrast to the introduced trading object being unavailable, the probability that the substitute transaction object is available is considered to be greater than 50%. Therefore, the possibility of purchase of the transaction object by the shopper can be enhanced by transmitting the transition page to the shopper terminal 5 rather than transmitting the URL of the purchase page of the introduced transaction object.

FIG. 2 is a diagram illustrating a screen transition example in the shopper terminal 5. For example, the shopper terminal 5 displays a certain web page as an information carrying medium. As illustrated in FIG. 2, the web page includes a sale item introduction section 100. The sale item introduction section 100 includes information on the item for sale which is introduced by the affiliate. The item for sale that is introduced is, for example, Tent A. For example, the sale item introduction section 100 may include a name, an image, an introduction sentence, and the like of the introduced item for sale. The sale item introduction section 100 includes a button 110. The button 110 is an affiliate link. Alternatively, the entire sale item introduction section 100 may be an affiliate link. In a case where Tent A is currently available, the shopper terminal 5 displays a purchase page of Tent A when the shopper presses the button 110.

In a case where Tent A sold in the online shopping mall is currently unavailable, the shopper terminal 5 displays a transition page 200 when the shopper presses the button 110. The transition page 200 includes, for example, an introduced sale item information section 210 and substitute sale item information sections 220-1, 220-2, and 220-3. Information on the introduced item for sale is displayed in the introduced sale item information section 210. In each substitute sale item information section, information on the item for sale to be a substitute for the introduced item for sale is displayed. The introduced sale item information section 210 and each substitute sale item information section may include, for example, a sale item name, a sale item image, the price, and the like. The introduced sale item information section 210 and each substitute sale item information section include a link to a purchase page of the item for sale corresponding to the information section. In the substitute sale item information section 220-1, information on Tent B is displayed. In the substitute sale item information section 220-2, information on Tent C is displayed. In the substitute sale item information section 220-3, information on Tent D is displayed. In the example of FIG. 2, information on the three substitute sale items is displayed. However, the number of substitute sale items for sale may be two or less or four or more. The transition page 200 may include information indicating that the introduced item for sale is unavailable. For example, the transition page 200 includes a message 230. The message 230 may be, for example, a message “The following item for sale is currently out of stock or not in a sales period.”. In addition, the transition page 200 may include information that encourages browsing of the purchase pages of the substitute sale items. For example, the transition page 200 includes a message 240. The message 240 may be, for example, a message “Please take a look at the following items for sale.”.

The shopper performs an operation to select, for example, the substitute sale item information section 220-1 from the transition page 200. In response to this operation, the shopper terminal 5 displays a sale item page 300. The sale item page 300 is a purchase page of Tent B that is a substitute sale item. When the shopper selects the introduced sale item information section 210, the shopper terminal 5 displays the sale item page of Tent A.

The affiliate server 1 may also give a reward to the affiliate when a substitute transaction object is purchased or when another transaction object is purchased. With this configuration, it is possible to suppress a decrease in opportunities for the affiliate to earn the reward.

### [2. Device Configuration]

### [2-1. Affiliate Server]

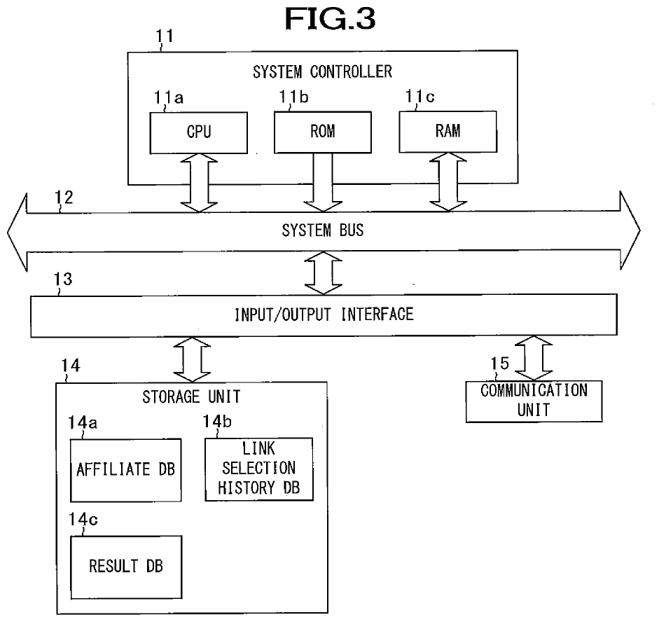

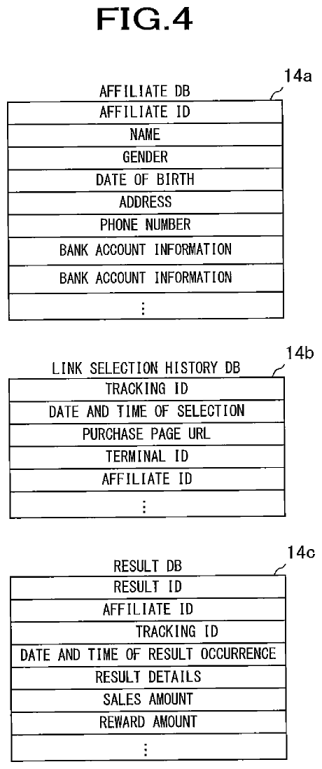

Next, a configuration of the affiliate server 1 will be described with reference to FIGS. 3 and 4. FIG. 3 is a block diagram illustrating an example of a schematic configuration of the affiliate server 1 according to the present embodiment. As illustrated in FIG. 3, the affiliate server 1 includes a system controller 11, a system bus 12, an input/output interface 13, a storage unit 14, and a communication unit 15. The system controller 11 and the input/output interface 13 are connected via the system bus 12.

The system controller 11 includes a central processing unit (CPU) 11a, a read only memory (ROM) 11b, a random access memory (RAM) 11c, and the like.

The input/output interface 13 performs interface processing between the storage unit 14 and the communication unit 15, and the system controller 11.

The storage unit 14 includes, for example, a hard disk drive or the like. The storage unit 14 stores databases such as an affiliate DB 14a, a link selection history DB 14b, and a result DB 14c. “DB” is an abbreviation for database.

FIG. 4 is a diagram illustrating an example of information stored in the databases in the affiliate server 1. The affiliate DB 14a stores affiliate information regarding affiliates registered in an affiliation service. For example, the affiliate DB 14a may store, as the affiliate information, an affiliate ID, a name, a date of birth, gender, an address, a telephone number, an e-mail address, bank account information, and the like in association with each other. The bank account information is information indicating a bank account to which the reward is to be transferred. The bank account information may include, for example, a bank name, a branch name, an account type, an account number, holder's name, and the like.

The link selection history DB 14b stores a history of selection of affiliate links in an information carrying medium. For example, in the link selection history DB 14b, every time an affiliate link is selected by any shopper, a tracking ID, date and time of the selection, a purchase page URL, a terminal ID, an affiliate ID, and the like may be stored as a link selection log in association with each other. The tracking ID is identification information for identifying the selection of the affiliate link indicated by the link selection log. The tracking ID may be used to track the behavior of the shopper after the shopper terminal 5 displays the purchase page of the transaction object by selecting the affiliate link. The date and time of the selection indicate the date and time when the affiliate link is selected. The purchase page URL indicates the URL of the purchase page to be referred to by the selected affiliate link. The terminal ID is identification information for identifying the shopper terminal 5 that has transmitted the request to the affiliate server 1 when the shopper selects the affiliate link. The terminal ID is stored in the shopper terminal 5 as an HTTP cookie (hereinafter, simply referred to as “cookie”). When transmitting a request to the affiliate server 1, the shopper terminal 5 storing the terminal ID transmits the terminal ID together with the request. The affiliate server 1 and the online shopping mall server 2 may belong to the same domain. In this case, when the shopper terminal 5 storing the terminal ID transmits a request to the online shopping mall server, the terminal ID is transmitted together with the request. When the shopper terminal 5 whose terminal ID is not stored accesses the affiliate server 1 or the online shopping mall server 2, the server device of the access destination issues a new terminal ID to the shopper terminal 5. The server device transmits a cookie including the terminal ID to the shopper terminal 5, and the shopper terminal 5 stores the cookie. As a result, the terminal ID is added to the request to be transmitted from the shopper terminal 5 to each of the affiliate server 1 and the online shopping mall server 2 in the future. The affiliate ID is identification information for identifying the affiliate who has posted the selected affiliate link on the information carrying medium.

In the result DB 14c, result information indicating that a shopper who has selected an affiliate link has purchased a transaction object is stored as a result of affiliating each time a result is achieved. For example, the result DB 14c may store a result ID, an affiliate ID, a tracking ID, date and time of the result occurrence, result details, a sales amount, a reward amount, and the like as result information in association with each other. The result ID is identification information for identifying the result information. The affiliate ID indicates an affiliate that has achieved a result. In other words, the affiliate ID in this case indicates an affiliate to which the reward is paid. The tracking ID indicates the selection of the affiliate link that has led to the occurrence of the result. The result details indicate detailed contents of the result. For example, the result details may include information for identifying a website in which the transaction object has been purchased, information for identifying the purchased transaction object, a purchase quantity of the transaction object, and the like. The sales amount indicates a purchase amount of the transaction object. The reward amount indicates the amount of the reward to be applied to the affiliate who has achieved the result. The reward amount may be an amount of money at a predetermined ratio to the sales amount.

The storage unit 14 further stores various programs such as an operating system, a database management system (DBMS), and an affiliate server program. The affiliate server program is a program that causes the system controller 11 to execute processing related to the affiliate. For example, the affiliate server program may be acquired from another device via the network NW, or may be recorded on a recording medium such as a magnetic tape, an optical disk, or a memory card and read via a drive device.

The communication unit 15 includes, for example, a network interface card or the like. The communication unit 15 is connected to the online shopping mall server 2, the affiliate terminal 4, the shopper terminal 5, and the like via the network NW, and controls communication states with the connected device.

### [2-2. Online Shopping Mall Server]

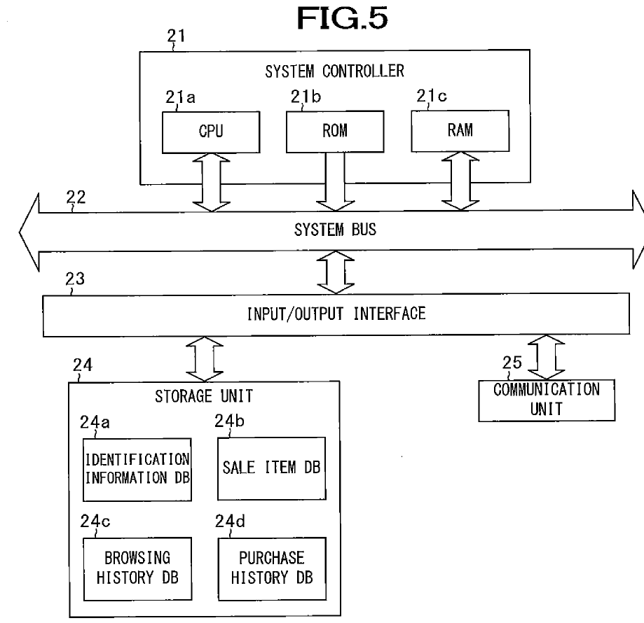

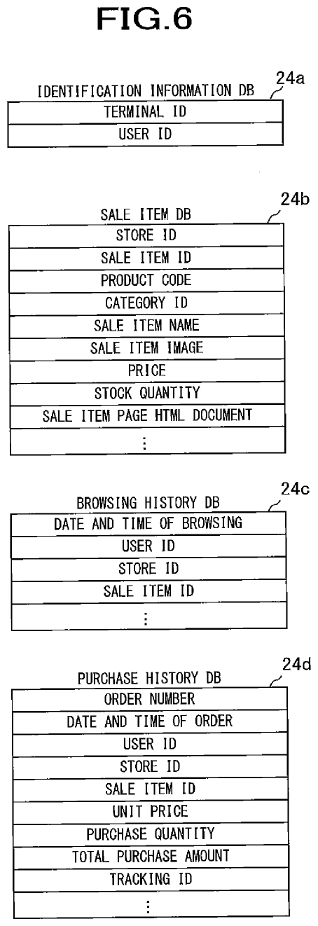

Next, a configuration of the online shopping mall server 2 will be described with reference to FIGS. 5 and 6. FIG. 5 is a block diagram illustrating an example of a schematic configuration of the online shopping mall server 2 according to the present embodiment. As illustrated in FIG. 5, the online shopping mall server 2 includes a system controller 21, a system bus 22, an input/output interface 23, a storage unit 24, and a communication unit 25. The system controller 21 and the input/output interface 23 are connected via the system bus 22.

The system controller 21 includes a CPU 21a, a ROM 21b, a RAM 21c, and the like.

The input/output interface 23 performs interface processing between the storage unit 24 and the communication unit 25, and the system controller 21.

The storage unit 24 includes, for example, a hard disk drive or the like. The storage unit 24 stores databases such as an identification information DB 24a, a sale item DB 24b, a browsing history DB 24c, and a purchase history DB 24d.

FIG. 6 is a diagram illustrating an example of information stored in databases in the online shopping mall server 2. In the identification information DB 24a, information for associating a shopper as a member of the online shopping mall with the shopper terminal 5 used by the shopper is stored regarding each shopper terminal 5. For example, the identification information DB 24a may store the terminal ID and the user ID in association with each other. As described above, the terminal ID is identification information for identifying the shopper terminal 5. The user ID is identification information for identifying a shopper who uses the shopper terminal 5. Since the terminal ID is associated with the user ID, the terminal ID is also identification information for substantially identifying the shopper. The shopper logs in to the online shopping mall or performs member registration of the online shopping mall. With this, the online shopping mall server 2 identifies the user ID of the user or issues a user ID. The online shopping mall server 2 stores, in an identification information DB 24a, the terminal ID transmitted from the shopper terminal 5 and the user ID of the shopper in association with each other.

In the sale item DB 24b, sale item information regarding items for sale that are sold in the online shopping mall is stored for each item for sale that is sold by each store. For example, the sale item DB 24b may store, as the sale item information, a store ID, a sale item ID, a product code, a category ID, a sale item name, a sale item image, a price, a sale item description, stock quantity, a sale item page HTML document, and the like in association with each other. The store ID is identification information for identifying a store that is a selling agency of the item for sale. The sale item ID is identification information for identifying the item for sale in the store of the selling agency. The product code is identification information for uniquely identifying the item for sale. The product code is different from the sale item ID in that the sale item ID is different when the store as the selling agency is different even for the same item for sale, and the same product code is assigned to the same item for sale regardless of which store is the selling agency. Examples of the product code include a Japanese Article Number (JAN) code. The category ID is identification information for identifying a category to which the item for sale belongs. Examples of the category of the item for sale include sports goods, fashion, fashion accessories, children's goods, home electric appliances, foods, and the like. The categories may be defined hierarchically. For example, there may be women's fashion, men's fashion, children's fashion, inner wear, and the like as a lower layer category of fashion. The category ID may be information for identifying a category of the lowermost layer. The sale item image is an image representing the item for sale or an image related to the item for sale. The stock quantity indicates the stock quantity of the item for sale. In a case where the stock quantity is one or more, the shopper can purchase the item for sale. When the stock quantity is zero, the shopper cannot purchase the item for sale. In this case, in the sale item page, both the operation of putting the item for sale in the shopping basket and the operation for proceeding to the purchase procedure of the item for sale may be prohibited. The sale item page HTML document is an HTML document indicating the display content of the sale item page of the item for sale.

The browsing history DB 24c stores a browsing history of a sale item page in the online shopping mall. For example, each time a sale item page is displayed, the browsing history DB 24c may store, as a browsing log, date and time of browsing, a user ID, a store ID, a sale item ID, and the like in association with each other. The date and time of browsing indicate the date and time when the sale item page is browsed. The user ID indicates a shopper who has browsed the sale item page. The store ID indicates a store as a selling agency of an item for sale whose information is carried by the browsed sale item page. The sale item ID indicates an item for sale whose information is carried by the browsed sale item page.

The purchase history DB 24d stores a purchase history regarding an item for sale in the online shopping mall. For example, every time an order for an item for sale is placed, an order number, date and time of the order, a user ID, a store ID, a sale item ID, a unit price, the purchase quantity, a total purchase amount, a tracking ID, and the like may be stored in the purchase history DB 24d in association with each other as a purchase log. The order number is identification information for identifying an order. The user ID indicates a shopper who has purchased the item for sale. The store ID indicates a store as a selling agency of the item for sale that has been purchased. The sale item ID indicates an item for sale that has been purchased. The unit price indicates the price of the item for sale at the time when the item for sale is purchased. The purchase quantity indicates how many pieces of the item for sale have been purchased. The total purchase amount indicates the total checkout price of the item for sale. The online shopping mall server 2 may calculate the total purchase amount by multiplying the unit price of the item for sale that has been purchased by the purchase quantity. The tracking ID indicates selection of the affiliate link that has led to the purchase of the item for sale. The tracking ID is stored in the purchase history DB 24d only in a case where the shopper purchases the item for sale after selecting the affiliate link.

The storage unit 24 further stores various programs such as an operating system, a DBMS, and an online shopping mall server program. The online shopping mall server program is a program that causes the system controller 21 to execute processing related to the online shopping mall. The online shopping mall server program may be acquired from another device via the network NW, or may be recorded on a recording medium such as a magnetic tape, an optical disk, or a memory card and read via a drive device.

The communication unit 25 includes, for example, a network interface card or the like. The communication unit 25 is connected to the affiliate server 1, the shopper terminal 5, and the like via the network NW, and controls the communication states with the connected devices.

### [3. Functional Overview]

### [3-1. Affiliate Server]

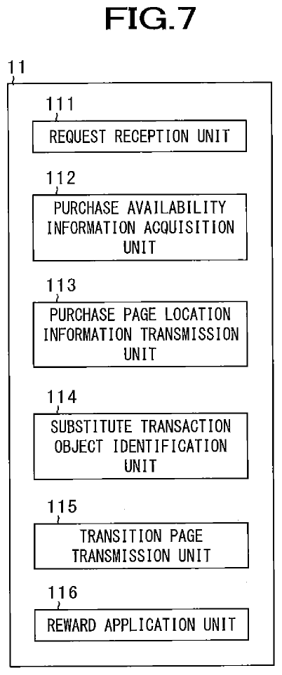

Next, an overview of the function of the system controller 11 in the affiliate server 1 will be described with reference to FIG. 7. FIG. 7 is a diagram illustrating an example of functional blocks of the system controller 11 in the affiliate server 1. When the CPU 11a reads and executes various program codes included in the affiliate server program, as illustrated in FIG. 7, the system controller 11 functions as a request reception unit 111, a purchase availability information acquisition unit 112, a purchase page location information transmission unit 113, a substitute transaction object identification unit 114, a transition page transmission unit 115, a reward application unit 116, and the like.

The request reception unit 111 receives a location request transmitted from the shopper terminal 5 used by the shopper in response to the operation of the shopper on the introduced transaction object reference information carried by the information carrying medium. The introduced transaction object reference information is reference information indicating a reference to an introduced transaction object purchase page which is a purchase page of a predetermined transaction object. The predetermined transaction object may be, for example, a transaction object selected in advance by an affiliate or a transaction object introduced by an affiliate. The introduced transaction object reference information may include an affiliate link of the transaction object to be introduced. The affiliate link is displayed by embedding the affiliate tag in the information carrying medium. The affiliate tag may include, for example, a URL of an introduced transaction object purchase page. In addition, the affiliate tag may include the URL of the affiliate server 1 to be the destination of the location request transmitted by the shopper terminal 5 in response to the shopper selecting the affiliate link. In addition, the affiliate tag may include identification information for identifying the introduced transaction object. This identification information may be included in the URL of the introduced transaction object purchase page. In addition, the affiliate tag may include the affiliate ID for identifying the affiliate introducing the transaction object. In addition, the affiliate tag may include a script for causing the shopper terminal 5 used by the shopper to transmit a location request to the affiliate server 1 when the affiliate link is selected by the shopper. The transmitted location request may include the URL of the introduced transaction object purchase page, identification information of the introduced transaction object, the affiliate ID, and identification information for identifying the shopper who has selected the affiliate link. The identification information of the shopper may be, for example, the terminal ID stored as a cookie by the shopper terminal 5.

The purchase availability information acquisition unit 112 acquires, in response to the reception of the location request from the shopper terminal 5 by the request reception unit 111, the purchase availability information indicating whether or not the predetermined transaction object can be purchased. Examples of the case where the transaction object cannot be purchased include that there is no stock of the transaction object, that the selling agency of the transaction object has ended or stopped the sales of the transaction object, that the selling agency of the transaction object has closed, and the like. The absence of the stock of the transaction object may indicate a situation in which the selling agency handles the transaction object, but there is no stock of the transaction object that can be currently sold. Examples of a case where there is no stock in a case where the transaction object is a service include a case where there is no room and no lodging date that can be reserved in reservation of lodging facilities, and a case where tickets are sold out in ticket sales. The termination or suspension of the sale of the transaction object may indicate a situation in which the sale is terminated or suspended for some reason different from a state of the stock.

The server device that manages the electronic commerce site may provide an application programming interface e (API) for acquiring the purchase availability information. The purchase availability information acquisition unit 112 may use this API to acquire the purchase availability information from the server device. For example, the purchase availability information acquisition unit 112 may acquire the purchase availability information from the server device by transmitting a request to the server device. The request may include identification information identifying the introduced transaction object. When the electronic commerce site is an online shopping site, this identification information may be a combination of a store ID and a sale item ID. The location request that the request reception unit 111 received from the shopper terminal 5 includes the URL of the sale item page of the introduced item for sale. The URL may include a store ID and a sale item ID of the item for sale. The purchase availability information acquisition unit 112 may acquire the purchase availability information from the online shopping mall server 2 by transmitting a request including the store ID and the sale item ID to the online shopping mall server 2. The server device that has received the request from the affiliate server 1 may transmit the purchase availability information stored in the server device in association with the identification information included in the request to the affiliate server 1. Alternatively, the server device may determine whether or not the transaction object identified by the identification information included in the request is purchasable. The server device may transmit the purchase availability information corresponding to the determination result to the affiliate server 1.

When the purchase availability information acquired by the purchase availability information acquisition unit 112 indicates that the introduced transaction object is available, the purchase page location information transmission unit 113 transmits the location information of the introduced transaction object purchase page to the shopper terminal 5. The location request transmitted from the shopper terminal 5 includes the URL of the introduced transaction object purchase page. The purchase page location information transmission unit 113 may transmit the URL to the shopper terminal 5.

In a case where the purchase availability information acquired by the purchase availability information acquisition unit 112 indicates that the introduced transaction object not available, the substitute transaction object identification unit 114 identifies a substitute transaction object that is a substitute for the transaction object.

The substitute transaction object may be a transaction object related to the introduced transaction object. As described above, there was a possibility that the shopper who has selected the affiliate link purchases the introduced transaction object. By presenting, as a substitute transaction object, a transaction object related to that transaction object, it is possible to increase the possibility of purchase of the substitute transaction object by the shopper. The related transaction object may be, for example, a transaction object that is the same in kind as or similar in kind to the introduced transaction object. In addition, the related transaction object may be a transaction object sold by the same selling agency as the selling agency of the introduced transaction object. In a case where the location request received from the shopper terminal 5 includes the identification information of the introduced transaction object, the purchase availability information acquisition unit 112 may identify the related transaction object on the basis of the identification information.

The substitute transaction object may be a transaction object according to a past behavior of the shopper who has selected the affiliate link. The transaction object according to the past behavior may be a transaction object that is determined to be likely to be selected by the user according to the behavior. The past behavior of the shopper may be a behavior related to the transaction object or may be another behavior. The behavior related to the transaction object may be selection of the transaction object. Examples of the selection of the transaction object include displaying a purchase page of the transaction object, purchasing the transaction object, and adding the transaction object to their favorites. The past behavior of the shopper may be a behavior on the electronic commerce site. The transaction object according to the past behavior of the shopper may be a transaction object determined from the behavior that the user is likely to select or purchase. For example, the transaction object according to the past behavior of the shopper may be the transaction object itself selected by the shopper in the past. In addition, the transaction object according to the past behavior of the shopper may be a transaction object related to the transaction object selected by the shopper in the past. In addition, the transaction object according to the past behavior of the shopper may be another transaction object that has been selected by another shopper who has selected the same transaction object as the transaction object selected by the shopper in the past. In a case where the location request received from the shopper terminal 5 includes the identification information of the shopper who has selected the affiliate link, the purchase availability information acquisition unit 112 may identify the transaction object according to the past behavior of the shopper according to the identification information.

The substitute transaction object may be a transaction object related to the introduced transaction object and may be a transaction object that is considered, from the past behavior of the shopper who has selected the affiliate link, to be possibly selected.

The server device that manages the electronic commerce site may provide an API for acquiring the related transaction object information as the information indicating the substitute transaction object. The related transaction object information may be information indicating a transaction object related to the designated transaction object or a transaction object related to the behavior of the designated shopper as the substitute transaction object. The related transaction object information may include at least one of identification information for identifying the substitute transaction object and a URL of the substitute transaction object purchase page that is a purchase page of the substitute transaction object. The substitute transaction object identification unit 114 may identify the substitute transaction object by acquiring the related transaction object information from the server device using the API. The related transaction object information may further include the name, price, image, description, and the like of the substitute transaction object. The substitute transaction object identification unit 114 may acquire the related transaction object information from a server device by transmitting a request to the server device managing the electronic commerce site. For example, the substitute transaction object identification unit 114 may acquire information indicating a transaction object related to the introduced transaction object from the server device by transmitting a request including identification information for identifying the introduced transaction object. In a case where the transaction object is an item for sale that is sold in the online shopping mall, the identification information of the item may be a combination of the store ID and the sale item ID. In addition, the substitute transaction object identification unit 114 may transmit a request including identification information for identifying the shopper who has selected the affiliate link, thereby acquiring, from the server device, information indicating the transaction object that is considered, from the past behavior of the shopper who has selected the affiliate link, to be possibly selected. The identification information of the shopper may be, for example, the terminal ID.

The substitute transaction object may be a transaction object confirmed to be currently available. The available transaction object may be, for example, a transaction object whose sale has not been terminated or suspended and there is available stock. Any of the affiliate server 1 and the online shopping mall server 2 may check whether or not the item is currently available for purchase. For example, in a case where the affiliate server 1 performs the check, after acquiring the related transaction object information from the electronic commerce site, the substitute transaction object identification unit 114 may acquire purchase availability information for each transaction object indicated by the related transaction object information from the electronic commerce site. Then, the substitute transaction object identification unit 114 may identify an available transaction object among the transaction objects indicated by the related transaction object information on the basis of the purchase availability information. Note that the substitute transaction object may be a transaction object that is not currently confirmed to be available. As described above, in contrast to the introduced transaction object being unavailable, the substitute transaction object may be in an available state. Therefore, the possibility of purchase of the transaction object by the shopper can be enhanced by transmitting the transition page to the shopper terminal 5 rather than transmitting the URL of the introduced transaction object purchase page.

The substitute transaction object may be a transaction object sold at the electronic commerce site where the introduced transaction object is sold. Alternatively, the substitute transaction object may be a transaction object sold at an electronic commerce site different from the electronic commerce site where the introduced transaction object is sold.

The substitute transaction object identification unit 114 may identify the substitute transaction object using the database stored in the affiliate server 1. For example, the substitute transaction object identification unit 114 may use any one of the link selection history DB 14b and the result DB 14c to identify, as the substitute transaction object, a transaction object that is likely to be selected by the shopper on the basis of the past behavior of the shopper who has selected the affiliate link. The link selection history DB 14b can be said to be a database indicating a history of browsing of a purchase page by the shopper. In addition, the result DB 14c can be said to be a database indicating a history of purchase of transaction objects by the shopper.

The transition page transmission unit 115 transmits, to the shopper terminal 5, a transition page on which the substitute transaction object reference information of the substitute transaction object identified by the substitute transaction object identification unit 114 is carried. The substitute transaction object reference information is reference information indicating a reference to the substitute transaction object purchase page. The substitute transaction object reference information may be a normal link. For example, when the substitute transaction object identification unit 114 acquires the related transaction object information from the electronic commerce site, the transition page transmission unit 115 may generate the substitute transaction object reference information on the basis of the related transaction object information to generate the transition page. The transition page may further include reference information of the introduced transaction object purchase page. The reference information in this case may be a normal link instead of an affiliate link.

When a substitute transaction object is purchased through the substitute transaction object purchase page displayed after the shopper selects the substitute transaction object reference information carried by the transition page transmitted by the transition page transmission unit 115, the reward application unit 116 executes processing of giving a reward to the affiliate who post the introduced transaction object reference information on the information carrying medium on the basis of the affiliate ID included in the location request received by the request reception unit 111. The purchase of the substitute transaction object through the purchase page may mean that the shopper performs a purchase procedure of the transaction object at that time or after the shopper performs a predetermined operation on the purchase page. Examples of the predetermined operation include an operation of placing the transaction object in a shopping container, an operation of selecting to proceed to a purchase procedure or a reservation procedure of the transaction object, and the like.

For example, when the transition page transmission unit 115 transmits the transition page, the reward application unit 116 may store the link selection log in the link selection history DB 14b. At this time, the reward application unit 116 acquires the affiliate ID from the location request received by the request reception unit 111. In addition, the reward application unit 116 generates a tracking ID. The reward application unit 116 generates a link selection log including the affiliate ID and the tracking ID. The reward application unit 116 may cause the shopper terminal 5 to store the generated tracking ID as a cookie. The cookie may have an expiration date. For example, the reward application unit 116 may cause the transition page transmission unit 115 to transmit the tracking ID to the shopper terminal 5 together with the transition page.

After the shopper terminal 5 stores the tracking ID, the shopper selects the substitute transaction object reference information from the transition page. In response to this selection, the shopper terminal 5 displays the substitute transaction object purchase page. Thereafter, the shopper performs a purchase procedure for the substitute transaction object. When this procedure is completed, the server device of the electronic commerce site may transmit the purchase information to the affiliate server 1. The purchase information is information indicating that the transaction object has been purchased. The purchase information may include, for example, the sales amount, the tracking ID stored in the shopper terminal 5, and the like. The reward application unit 116 may generate result information on the basis of the purchase information received from the server device of the electronic commerce site. At this time, the reward application unit 116 may search the link selection history DB 14b for a link selection log including the same tracking ID as the tracking ID included in the purchase information. The reward application unit 116 may acquire the affiliate ID included in the found link selection log as information for identifying the affiliate to which the reward is to be paid. Then, the reward application unit 116 may store result information including the affiliate ID, the reward amount, and the like in the result DB 14c. The reward application unit 116 may execute processing of transferring the reward to the bank account of the affiliate on the basis of the result information and the account information of the affiliate.

### [3-2. Online Shopping Mall Server]

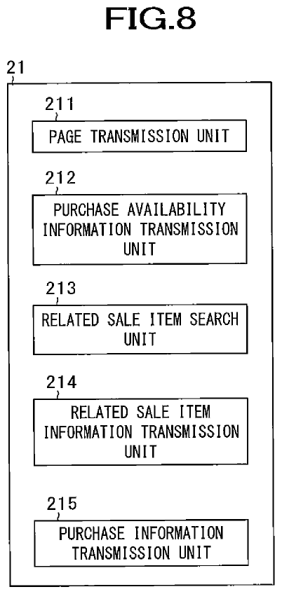

Next, a functional outline of the system controller 21 in the online shopping mall server 2 will be described with reference to FIG. 8. FIG. 8 is a diagram illustrating an example of functional blocks of the system controller 21 in the online shopping mall server 2. When the CPU 21a reads and executes various program codes included in the online shopping mall server program, the system controller 11 functions as a page transmission unit 211, a purchase availability information transmission unit 212, a related sale item search unit 213, a related sale item information transmission unit 214, a purchase information transmission unit 215, and the like as illustrated in FIG. 8.

In response to the request transmitted from the shopper terminal 5 to the online shopping mall server 2, the page transmission unit 211 transmits the web page of the online shopping mall to the shopper terminal 5. For example, the page transmission unit 211 transmits a web page corresponding to the URL included in the request. For example, in a case where the requested web page is a sale item page of a certain item for sale, the URL may include a store ID and a sale item ID of the item. The page transmission unit 211 may transmit the sale item page by transmitting the sale item page HTML document stored in the sale item DB 24b in association with the combination of the store ID and the sale item ID.

In response to a request from the affiliate server 1, the purchase availability information transmission unit 212 transmits, to the affiliate server 1, purchase availability information indicating whether or not the transaction object introduced by the affiliate is available for purchase. For example, the request transmitted from the affiliate server 1 includes the store ID and the sale item ID of the introduced item for sale. The purchase availability information transmission unit 212 may acquire or determine the purchase availability information on the basis of the store ID and the sale item ID.

For example, the purchase availability information transmission unit 212 may transmit stock information indicating whether or not the item for sale is in stock as the purchase availability information. The stock information may indicate the presence or absence of the stock itself or the stock quantity. For example, the purchase availability information transmission unit 212 may transmit, as the stock information, the stock quantity stored in the sale item DB 24b in association with the combination of the store ID and the sale item ID of the introduced item for sale.

The sale item information stored in the sale item DB 24b of the online shopping mall server 2 may include sales status information indicating whether or not the item for sale is currently sold by the store. The sales status information may be set by the store. The purchase availability information transmission unit 212 may transmit the sales status information as the purchase availability information.

The online shopping mall server 2 may delete the sale item information of the item for sale whose sale has ended from the sale item DB 24b. Furthermore, the online shopping mall server 2 may delete, from the sale item DB 24b, the sale item information of the item for sale that was sold by a store that has closed. In these cases, the purchase availability information transmission unit 212 may determine the purchase availability y information to be transmitted to the affiliate server 1 by determining whether there is the sale item information of the item for sale that is inquired from the affiliate server 1.

In response to a request from the affiliate server 1, the related sale item search unit 213 searches for at least one of an item for sale that is related to the item for sale and an item for sale that is related to the shopper who has selected the affiliate link as a substitute for the item for sale as a substitute sale item for the item for sale that is introduced by the affiliate. For example, in a case where the request transmitted from the affiliate server 1 includes the store ID and the sale item ID of the introduced item for sale, the related sale item search unit 213 may search for an item related to the introduced item for sale as the substitute sale item. For example, the related sale item search unit 213 may identify the sale item information associated with the store ID and the sale item ID of the introduced item from the sale item DB 24b. The related sale item search unit 213 may search for an item for sale that is the same in kind as or similar in kind to the introduced item for sale on the basis of the category ID or the product code included in the sale item information. Examples of a group of the same kinds of items for sale include a category, a manufacturer, a brand, and a series. The category of the item for sale can be identified on the basis of the category ID. In addition, the manufacturer, the brand, or the series may be identified from the product code. For example, the storage unit 24 of the online shopping mall server 2 may store a specification DB. The specification DB is a database that stores information indicating specification of each item for sale. For example, the specification DB may store a product code, a sale item name, a manufacturer ID, a brand ID, a series ID, and the like for each item for sale. The manufacturer ID is identification information for identifying the manufacturer. The brand ID is identification information for identifying the brand. The series ID is identification information for identifying the series. The related sale item search unit 213 may search for an item for sale that is sold by the same store as the store as the selling agency of the item for sale on the basis of the store ID of the introduced item for sale.

In a case where the request transmitted from the affiliate server 1 includes the terminal ID of the shopper who has selected the affiliate link, the related sale item search unit 213 may search for an item for sale according to the past behavior of the shopper as the substitute sale item. For example, the related sale item search unit 213 may acquire the user ID stored in the identification information DB 24a in association with the terminal ID. The related sale item search unit 213 may acquire a behavior history of the shopper who has selected the affiliate link on the basis of the user ID. The behavior history of the shopper may be, for example, at least one of a browsing history stored in the browsing history DB 24c and a purchase history stored in the purchase history DB 24d. The related sale item search unit 213 may search for a substitute sale item on the basis of the acquired history. For example, the related sale item search unit 213 may search for an item for sale that is selected in the past by the shopper who has selected the affiliate link as a substitute sale item. Alternatively, the related sale item search unit 213 may search for an item for sale that is related to the item for sale that is selected in the past by the shopper who has selected the affiliate link as a substitute sale item. Alternatively, the related sale item search unit 213 may search for another item for sale that has been selected by another shopper who has selected the same item as the item selected by the shopper who has selected the affiliate link in the past as the substitute sale item. In this case, the related sale item search unit 213 may search for the substitute sale item using, for example, collaborative filtering.

The related sale item information transmission unit 214 transmits, to the affiliate server 1, related sale item information indicating the substitute sale item found by the related sale item search unit 213 as the related transaction object information. The related sale item information may include at least one of a combination of the store ID and the sale item ID of the substitute sale item and the URL of the sale item page of the substitute sale item. For example, the related sale item information transmission unit 214 may transmit all or part of the sale item information of the substitute sale item as the related sale item information.

In a case where the shopper purchases an item for sale at the online shopping mall after selecting the affiliate link, the purchase information transmission unit 215 transmits purchase information indicating the purchase to the affiliate server 1. The purchase information may include at least a tracking ID for identifying an affiliate link that has caused the purchase of the item for sale, and a total purchase amount. As described above, when the shopper selects the affiliate link, the shopper terminal 5 stores the tracking ID as a cookie. The request transmitted from the shopper terminal 5 to the online shopping mall server 2 includes the terminal ID stored in the shopper terminal 5. Therefore, the online shopping mall server 2 can acquire the terminal ID. The total purchase amount corresponds to the sales amount at the affiliate. When an item for sale is purchased, the online shopping mall server 2 stores the purchase log in the purchase history DB 24d. The purchase information transmission unit 215 may transmit all or a part of the purchase log as the purchase information.

### [4. Operation of Affiliate System]

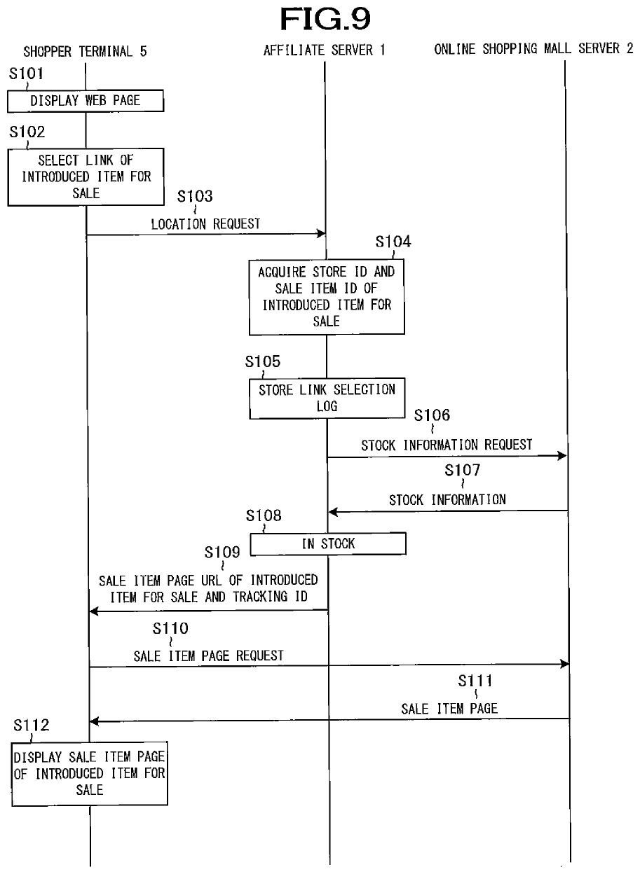

Next, the operation of the affiliate system S will be described with reference to FIGS. 9 to 11. FIG. 9 is a sequence diagram illustrating a processing example of the affiliate system S in a case where the item for sale that is introduced by the affiliate is available to purchase.

As illustrated in FIG. 9, the shopper terminal 5 receives and displays a web page from the web server 3 in response to a request from the shopper (step S101). This web page contains content created by the affiliate. This content includes an introduction of an item for sale by the affiliate and also includes an affiliate link of the item for sale. The shopper selects this affiliate link from the displayed web page (step S102). In response to this selection, the shopper terminal 5 transmits a location request to the affiliate server 1 according to the affiliate tag embedded in the web page (step S103). At this time, the shopper terminal 5 may include the URL of the sale item page and the affiliate ID included in the affiliate tag in the location request. In addition, the shopper terminal 5 may include the terminal ID stored in the shopper terminal 5 in the location request.

The purchase availability information acquisition unit 112 of the affiliate server 1 that has received the location request acquires the store ID and the sale item ID of the introduced item for sale from the URL of the sale item page included in the location request (step S104). Next, the reward application unit 116 stores the link selection log in the link selection history DB 14b (step S105). At this time, the reward application unit 116 may generate the tracking ID. Furthermore, the reward application unit 116 may acquire the URL of the sale item page, the affiliate ID, and the terminal ID from the location request. The reward application unit 116 may generate a link selection log including the tracking ID, the URL, the affiliate ID, and the terminal ID.

Next, the purchase availability information acquisition unit 112 transmits a stock information request including the store ID and the sale item ID of the introduced item for sale to the online shopping mall server 2 (step S106). The purchase availability information transmission unit 212 of the online shopping mall server 2 that has received the stock information request transmits the stock quantity stored in the sale item DB 24b in association with the combination of the store ID and the sale item ID of the introduced item for sale to the affiliate server 1 as stock information (step S107).

The purchase availability information acquisition unit 112 of the affiliate server 1 that has received the stock information determines whether there is a stock of introduced item for sale on the basis of the stock information. Here, it is assumed that the purchase availability information acquisition unit 112 determines that there is a stock of the item for sale (step S108). In this case, the purchase page location information transmission unit 113 transmits a response including the URL of the introduced item for sale and the generated tracking ID to the shopper terminal 5 (step S109).

The shopper terminal 5 that has received the response stores the tracking ID. In addition, the shopper terminal 5 transmits a sale item page request including the URL of the introduced item for sale to the online shopping mall server 2 (step S110). The page transmission unit 211 of the online shopping mall server 2 that has received the sale item page request transmits the sale item page corresponding to the URL included in the sale item page request to the shopper terminal 5 (step S111). The shopper terminal 5 displays the received sale item page (step S112).

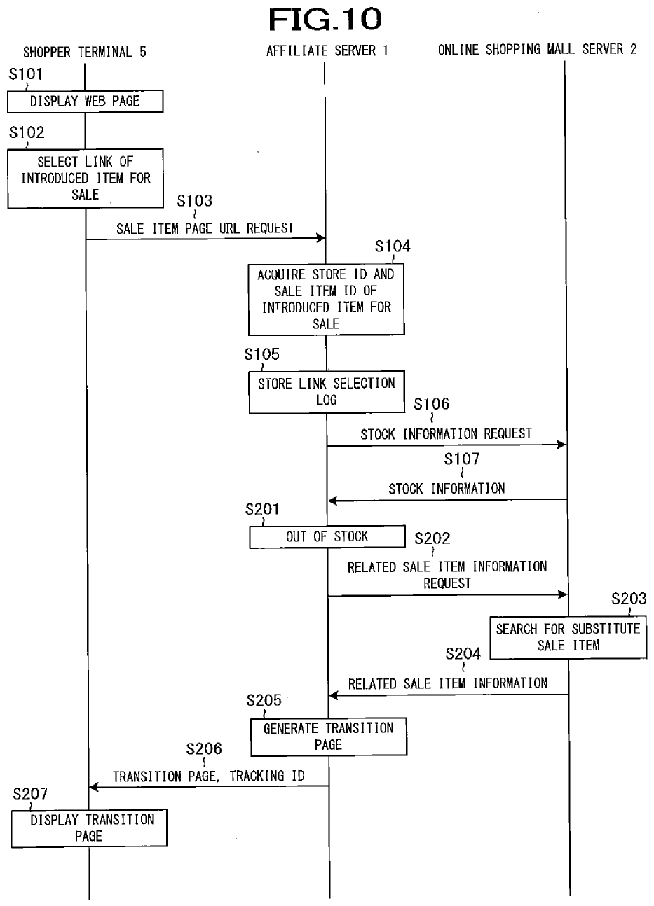

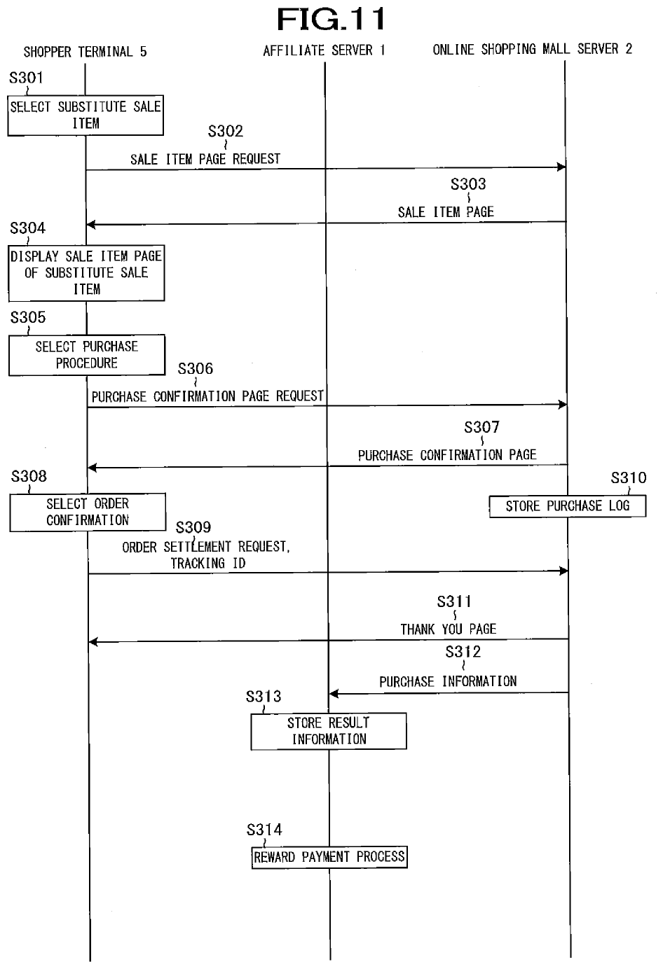

FIGS. 10 and 11 are sequence diagrams illustrating processing examples of the affiliate system S in a case where the item for sale that is introduced by the affiliate is not available for purchase. In FIG. 10, the same steps as those in FIG. 9 are denoted by the same reference numerals.

As illustrated in FIG. 10, steps S101 to S107 are executed first as in the case of FIG. 9. Next, it is assumed that the purchase availability information acquisition unit 112 determines that there is no stock of introduced item for sale (step S201). In this case, the substitute transaction object identification unit 114 transmits a related sale item information request to the online shopping mall server 2 (step S202). At this time, the substitute transaction object identification unit 114 may include the store ID and the sale item ID of the introduced item for sale and the terminal ID of the shopper terminal 5 in the related sale item information request.

The related sale item search unit 213 of the online shopping mall server 2 that has received the related sale item information request searches for one or more substitute sale items (step S203). For example, the related sale item search unit 213 may acquire the user ID associated with the terminal ID included in the related sale item information request from the identification information DB 24a. The related sale item search unit 213 may search a log including the acquired user ID from at least one of the browsing history DB 24c and the purchase history DB 24d. As a result, the related sale item search unit 213 may identify an item for sale that has been selected by the shopper who has selected the affiliate link. Then, the related sale item search unit 213 may search for another item for sale that has been selected by another shopper who has selected the same item for sale as the sale item selected by the shopper who has selected the affiliate link, using, for example, collaborative filtering. The related sale item search unit 213 may acquire the sale item information of each found item for sale from the sale item DB 24b. The related sale item search unit 213 may acquire the category ID from the sale item information of each found item for sale, and may also acquire the category ID from the sale item information of the introduced item for sale. The related sale item search unit 213 may extract item for sale belonging to the same category as the category to which the introduced item for sale belongs from the found items for sale on the basis of the category ID. The related sale item search unit 213 may determine a predetermined number of items for sale among the extracted items for sale as substitute sale items. Next, the related sale item information transmission unit 214 acquires the sale item information of the substitute sale item from the sale item DB 24b. Then, the related sale item information transmission unit 214 transmits the sale item information of the substitute sale item as the related sale item information to the affiliate server 1 (step S204). At this time, the related sale item information transmission unit 214 may also transmit the sale item information of the introduced item for sale.

Upon receiving the related sale item information, the transition page transmission unit 115 of the affiliate server 1 generates a transition page (step S205). For example, the transition page transmission unit 115 may generate the substitute sale item information section on the basis of a sale item page HTML document included in the related sale item information. Alternatively, the transition page transmission unit 115 may generate the substitute sale item information section by using the sale item name, the sale item image, and the price included in the related sale item information. The transition page transmission unit 115 may generate the introduced sale item information section in a similar manner. The transition page transmission unit 115 may use the store ID and the sale item ID of each item for sale to generate the URL of the sale item page of the item for sale. In the URLs of the sale item pages, the content of the portion excluding the store ID and the sale item ID may be common to all the sale item pages. The transition page transmission unit 115 may use the URL of the sale item page to generate a tag for displaying a link to the sale item page. The transition page transmission unit 115 may generate a substitute sale item information section or an introduced sale item information section including this tag for each item for sale. The transition page transmission unit 115 may generate a transition page including a substitute sale item information section and an introduced sale item information section. The transition page transmission unit 115 transmits the generated transition page and the generated tracking ID to the shopper terminal 5 (step S206). The shopper terminal 5 stores the tracking ID and displays the transition page (step S207).

Note that, in a case where only the item for sale that can be currently purchased is identified as the substitute sale item, the affiliate server 1 may regard, for example, each sale item for which the substitute sale item information has been received from the online shopping mall server 2 in step S204 as a candidate for the substitute sale item. The affiliate server 1 may transmit stock request information to the online shopping mall server 2 for each candidate for the substitute sale item. With this configuration, the purchase availability information acquisition unit 112 may acquire the purchase availability information of each candidate. Then, the affiliate server 1 may identify, as the substitute sale item, an item for sale in stock among the candidates for the substitute sale item on the basis of the purchase availability information.

In a state in which the shopper terminal 5 displays the transition page, as illustrated in FIG. 11, it is assumed that the shopper selects the substitute sale item information section of any substitute sale item from the transition page (step S301). In response to this selection, the shopper terminal 5 transmits a sale item page request including the URL of the substitute sale item embedded in the selected substitute sale item information section to the online shopping mall server 2 (step S302). The page transmission unit 211 of the online shopping mall server 2 that has received the sale item page request transmits the sale item page of the substitute sale item corresponding to the URL included in the sale item page request to the shopper terminal 5 (step S303). The shopper terminal displays the sale item page of the substitute sale item (step S304).

Thereafter, it is assumed that the shopper performs an operation of selecting a purchase procedure on the sale item page of the substitute sale item (step S306). In response to this operation, the shopper terminal 5 transmits a purchase confirmation page request to the online shopping mall server 2 (step S306). The online shopping mall server 2 that has received the purchase confirmation page request transmits the purchase confirmation page to the shopper terminal 5 (step S307). The purchase confirmation page may be a web page for the shopper to confirm and edit the purchase content of the item for sale. For example, it may be possible to confirm or edit the purchase quantity, the payment method, the shipping address of the item for sale, and the like. On the purchase confirmation page, the shopper performs an operation to select confirmation of the order (step S308). In response to this operation, the shopper terminal 5 transmits an order settlement request to the online shopping mall server 2 (step S309). The order settlement request may include the store ID and the sale item ID of the item for sale that is to be purchased, the purchase quantity, and other purchase contents. In addition, the order settlement request may include a tracking ID stored in the shopper terminal 5.

The online shopping mall server 2 that has received the order settlement request stores the purchase log in the purchase history DB 24d on the basis of the order settlement request (step S310). For example, the online shopping mall server 2 may acquire, from the sale item DB 24b, sale item information including a combination of the store ID and the sale item ID included in the order settlement request. The online shopping mall server 2 may acquire a price from the sale item information. The online shopping mall server 2 may calculate the total purchase amount by multiplying the price by the purchase quantity. The online shopping mall server 2 may acquire the reception date and time of the order settlement request as the order date and time. The online shopping mall server 2 may generate a purchase log including the store ID and the sale item ID, the purchase quantity, the total purchase amount, the order date and time, the tracking ID, and the like of the item for sale that has been purchased and store the purchase log in the purchase history DB 24d. Next, the page transmission unit 211 transmits a thank you page to the shopper terminal 5 (step S311). The thank you page is a web page that expresses gratitude to the shopper for purchasing an item for sale. Next, the purchase information transmission unit 215 transmits the purchase information to the affiliate server 1 (step S312). For example, the purchase information transmission unit 215 may include the total purchase amount in the purchase information as the sales amount. In addition, purchase information transmission unit 215 may include the tracking ID in the purchase information. In addition, purchase information transmission unit 215 may include the purchase date and time in the purchase information as date and time of result occurrence. The reward application unit 116 of the affiliate server 1 that has received the purchase information stores the result information in the result DB 14c on the basis of the purchase information (step S313). For example, the reward application unit 116 may search the link selection log including the tracking ID included in the purchase information from the link selection history DB 14b. The reward application unit 116 may acquire the affiliate ID from the found link selection log. The reward application unit 116 may calculate the reward amount by multiplying the sales amount included in the purchase information by a predetermined ratio. The reward application unit 116 may generate result information by using the affiliate ID, the tracking ID, the date and time of result occurrence, the sales amount, and the reward amount.

Thereafter, the reward application unit 116 executes reward payment processing on a specific day (step S314). For example, the reward payment process may be performed on the last day of each month. In the reward payment processing, the reward application unit 116 may search the result DB 14c for result information whose result occurrence date and time are within the previous month, for example. The reward application unit 116 may divide the result information for each affiliate on the basis of the affiliate ID included in the found result information. For each affiliate, the reward application unit 116 may calculate a total of the reward amounts included in all the result information of the affiliate as the reward amount for the previous month. In addition, the reward application unit 116 may acquire the account information of each affiliate from the affiliate DB 14a. The reward application unit 116 may execute processing of remitting the previous month's reward from the account of the affiliate provider to the account of the affiliate by cooperating with the online system of banks on the basis of the account information.

As described above, according to the present embodiment, the affiliate server 1 receives the location request transmitted from the shopper terminal 5 of the shopper in response to the operation by the shopper on the introduced transaction object reference information indicating the reference to the introduced transaction object purchase page, which is carried by the information carrying medium. In addition, in response to the reception of the location request, the affiliate server 1 acquires purchase availability information indicating whether or not the introduced transaction object can be purchased. In addition, when the purchase availability information indicates that the introduced transaction object can be purchased, the affiliate server 1 transmits location information indicating the location of the introduced transaction object purchase page to the shopper terminal 5. In addition, in a case where the purchase availability information indicates that the introduced transaction object cannot be purchased, the affiliate server 1 identifies the substitute transaction object. In addition, the affiliate server 1 transmits a transition page carrying substitute transaction object reference information indicating a reference to the substitute transaction object purchase page to the shopper terminal 5. According to these processes, when the reference information of the introduced transaction object purchase page for purchase of the introduced transaction object is operated by the shopper on the information carrying medium, purchase availability information indicating whether or not purchase of the transaction object is available is acquired. In a case where the purchase of the introduced transaction object is available, the location information of the introduced transaction object purchase page is transmitted to the shopper terminal 5 of the shopper. The shopper terminal 5 acquires and displays the introduced transaction object purchase page from an electronic commerce site on the basis of the location information. The shopper can purchase the transaction object introduced through the introduced transaction object purchase page. When the purchase of the introduced transaction object is not available, the transition page is transmitted to the shopper terminal 5. In the transition page, reference information of a substitute transaction object purchase page for a substitute transaction object purchase page is carried. When the shopper performs a predetermined operation on the reference information on the transition page displayed by the shopper terminal 5, the shopper terminal 5 acquires and displays the substitute transaction object purchase page from the electronic commerce site. Performing an operation on the reference information of the introduced transaction object purchase page in the information carrying medium is an action indicating that there is a possibility that the shopper has become interested in the introduced transaction object. The substitute transaction object is a transaction object that is a substitute for the introduced transaction object. Therefore, there is a possibility that the shopper purchases the substitute transaction object. Therefore, in the medium outside the electronic commerce site, it is possible to increase the possibility of purchase by the shopper who has performed the operation for displaying the web page for purchase of the transaction object in the electronic commerce site.

Here, when the substitute transaction object is purchased through the substitute transaction object purchase page displayed by selecting the substitute transaction object reference information carried by the transition page, the affiliate server 1 may execute processing of giving a reward to the affiliate on the basis of the affiliate ID included in the location request received from the shopper terminal 5. In this case, when the shopper performs a predetermined operation on the reference information on the transition page, the shopper terminal 5 acquires and displays the substitute transaction object purchase page from the electronic commerce site. Thereafter, when the shopper purchases the substitute transaction object, a reward is given to the affiliate who has put the reference information of the introduced transaction object purchase page on the information carrying medium. Therefore, even in a case where the purchase of the introduced transaction object is not available, the affiliate introducing the introduced transaction object can obtain an opportunity to get a reward for the introduction.

In addition, in a case where the stock information indicates that the introduced transaction object is in stock as the purchase availability information, the affiliate server 1 may transmit the location information of the introduced transaction object purchase page. In addition, in a case where the stock information indicates that the introduced transaction object is not in stock, the affiliate server 1 may identify the substitute transaction object and transmit the transition page. In this case, even when the introduced transaction object is not in stock, the possibility of purchase by the shopper can be improved.

In addition, the affiliate server 1 may identify the transaction object confirmed to be available as the substitute transaction object. In this case, the transition page includes reference information of the substitute transaction object purchase page for purchase of a transaction object confirmed to be available. Therefore, the possibility of purchase by the shopper can be further enhanced.

In addition, the affiliate server 1 may identify a transaction object related to the introduced transaction object as the substitute transaction object on the basis of the identification information of the transaction object included in the location request. In this case, the transition page carries reference information of the substitute transaction object purchase page for purchase of the transaction object related to the introduced transaction object. The shopper who is interested in the introduced transaction object may purchase a related transaction object. Therefore, the possibility of purchase by the shopper can be increased.

In addition, the affiliate server 1 may identify a transaction object that is considered, from the past behavior of the shopper, to be possibly selected by the shopper on the basis of as the substitute transaction object according to the terminal ID included in the location request. In this case, the reference information of the substitute transaction object purchase page for purchase of the transaction object that is considered, from the past behavior of the shopper, to be possibly selected by the shopper is carried by the transition page. The transaction object that is possibly selected is a transaction object that the user may be interested in. Therefore, the possibility of purchase by the shopper can be increased.

Furthermore, the introduced transaction object reference information may include an affiliate link for the introduced transaction object.

### REFERENCE SIGNS LIST

1: Affiliate server
2: Online shopping mall server
3: Web server
4: Affiliate terminal
5: Shopper terminal
11: System controller
12: System bus
13: Input/output interface
14: Storage unit
14a: Affiliate DB
14b: Link selection history DB
14c: Result DB
25: Communication unit
21: System controller
22: System bus
23: Input/output interface
24: Storage unit
24a: Identification information DB
24b: Sale item DB
24c: Browsing history DB
24d: Purchase history DB
25: Communication unit
111: Request reception unit
112: Purchase availability information acquisition unit
113: Purchase page location information transmission unit
114: Substitute transaction object identification unit
115: Transition page transmission unit
116: Reward application unit
211: page transmission unit
212: purchase availability information transmission unit
213: related sale item search unit
214: related sale item information transmission unit.
215: purchase information transmission unit
NW: Network

1. An information processing device comprising:
at least one memory configured to store computer program code;
at least one processor configured to access the memory and operate as instructed by the computer program code, the computer program code comprising;
reception code configured to cause at least one of the at least one processor to receive means that receives a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page;
acquisition code configured to cause at least one of the at least one processor to acquire, in response to the request being received by the reception code, purchase availability information indicating whether purchase of the predetermined transaction object is available;
first transmission code configured to cause at least one of the at least one processor to transmit location information indicating a location of the first web page to the terminal device in response to the acquired purchase availability information indicating that the purchase of the predetermined transaction object is available;
identification code configured to cause at least one of the at least one processor to identify a substitute transaction object as a substitute for the predetermined transaction object in response to the acquired purchase availability information indicating that the purchase of the predetermined transaction object is not available; and
second transmission code configured to cause at least one of the at least one processor to transmit a substitute web page carrying substitute transaction object reference information indicating a reference to a second web page for purchase of the identified substitute transaction object.

2. The information processing device according to claim 1, wherein
the predetermined transaction object reference information carried by the information carrying medium includes poster identification information that identifies a poster who posted the predetermined transaction object reference information, and
the received request includes the poster identification information included in the predetermined transaction object reference information,
the information processing device further comprising
giving code configured to cause at least one of the at least one processor to perform processing to give a reward to the poster on the basis of the poster identification information included in the received request in response to the substitute transaction object being purchased via the second web page that is displayed by selecting the substitute transaction object reference information carried by the transmitted substitute web page.

3. The information processing device according to claim 1, wherein
the acquired purchase availability information indicates whether the predetermined transaction object is in stock,
in response to the acquired purchase availability information indicating that the predetermined transaction object is in stock, the first transmission code is configured to cause at least one of the at least one processor to transmit the location information, and
in response to the acquired purchase availability information indicating that the predetermined transaction object is not in stock, the identification code is configured to cause at least one of the at least one processor to identify the substitute transaction object and the second transmission code is configured to cause at least one of the at least one processor to transmit the substitute web page.

4. The information processing device according to claim 1, wherein
the identification code is configured to cause at least one of the at least one processor to identify, as the substitute transaction object, a transaction object that has been confirmed to be available.

5. The information processing device according to claim 1, wherein
the received request includes transaction object identification information for identifying the predetermined transaction object, and
the identification code is configured to cause at least one of the at least one processor to identify, as the substitute transaction object, the transaction object related to the predetermined transaction object on the basis of the transaction object identification information included in the received request.

6. The information processing device according to claim 1, wherein
the received request includes user identification information for identifying the user, and
the identification code is configured to cause at least one of the at least one processor to identify, as the substitute transaction object, a transaction object that is considered, from past behavior of the user, to be possibly selected by the user on the basis of the user identification information included in the received request.

7. The information processing device according to claim 1, wherein
the predetermined transaction object reference information includes an affiliate link regarding the predetermined transaction object.

8. An information processing method to be executed by computer, the method comprising:
a reception step of receiving a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page;
an acquisition step of acquiring, in response to the request being received in the reception step, purchase availability information indicating whether purchase of the predetermined transaction object is available;
a first transmission step of transmitting location information indicating a location of the first web page to the terminal device in response to the acquired purchase availability information indicating that the purchase of the predetermined transaction object is available;
an identification step of identifying a substitute transaction object as a substitute for the predetermined transaction object in response to the acquired purchase availability information indicating that the purchase of the predetermined transaction object is not available; and
a second transmission step of transmitting a substitute web page carrying substitute transaction object reference information indicating a reference to a second web page for purchase of the identified substitute transaction object.

9. A non-transitory computer readable medium storing thereon an information processing program causing a computer to:
receive a request transmitted from a terminal device of a user, the request being transmitted in response to an operation by the user on predetermined transaction object reference information carried by an information carrying medium other than a first web page for purchase of a predetermined transaction object, the predetermined transaction object reference information indicating a reference to the first web page;
acquire, in response to the request being received, purchase availability information indicating whether purchase of the predetermined transaction object is available;
transmit location information indicating a location of the first web page to the terminal device in response to the acquired purchase availability information indicating that the purchase of the predetermined transaction object is available;
identify a substitute transaction object as a substitute for the predetermined transaction object in response to the acquired purchase availability information indicating that the purchase of the predetermined transaction object is not available; and
transmit a substitute web page carrying substitute transaction object reference information indicating a reference to a second web page for purchase of the identified substitute transaction object.
